(19) United States
(12) Patent Application Publication
(10) Pub. No.: US 2025/0222952 A1
(43) Pub. Date: Jul. 10, 2025

(54) SYSTEMS AND METHODS FOR INCENTIVIZED BEHAVIOR OF AUTONOMOUS VEHICLES

(71) Applicant: Torc Robotics, Inc., Blacksburg, VA (US)

(72) Inventors: Joseph R. Fox-Rabinovitz, Blacksburg, VA (US); Pablo Smith, Blacksburg, VA (US); William Davis, Blacksburg, VA (US); Akshay Pai Raikar, Blacksburg, VA (US); Mihir Deshingkar, Blacksburg, VA (US); Justin Yurkanin, Blacksburg, VA (US)

(21) Appl. No.: 18/407,262

(22) Filed: Jan. 8, 2024

(51) Int. Cl. B60W 60/00; G06Q 20/38

(52) U.S. Cl. CPC B60W 60/001; G06Q 20/3821; B60W 2540/047

(57) ABSTRACT

An autonomous vehicle includes an autonomy computing system and an exterior surface displaying an indicium. The autonomy computing system includes an incentivized behavior module. The autonomy computing system further includes at least one processor and at least one memory. The processor is configured to establish communication between a client device of a user and the autonomous vehicle using the indicium. The processor is configured to receive, at least one request from the client device, the at least one request including a desired action of the autonomous vehicle. The processor is configured to initiate execution of the desired action. The processor is configured to communicate to the client device whether the autonomous vehicle will complete the requested action.

### TECHNICAL FIELD

The field of the disclosure relates generally to decision making of autonomous vehicles and, more specifically, allowing users proximate to the autonomous vehicle to submit requests for incentivized behavior of the autonomous vehicle. This incentivized behavior may result in more courteous driving of the autonomous vehicle.

### BACKGROUND

Autonomous vehicles are constantly evaluating their environment and analyzing data to make decisions about operation of the vehicle. Autonomous vehicles regularly receive large amounts of data that is then processed to provide context on the environment in relation to the operation of the autonomous vehicle.

Autonomous vehicles share the roadway with vehicles under manual control, semi-autonomous vehicles, and fully autonomous vehicles. Autonomous vehicles can operate with greater efficiency than vehicles operated by human drivers. For example, autonomous vehicles are constantly processing data pertaining to their surroundings and, in some instances, autonomous vehicles may suffer from courtesy failures. Specifically, in such instances, the autonomous vehicle may operate in ways that may be deemed inconvenient or discourteous to other drivers. Some examples of this discourteous behavior may include blocking lanes in congested conditions or driving slowly. In such scenarios, it would be courteous to other drivers, vehicles, or pedestrians for the truck to change lanes, change speed, exit the highway, pull over, or turn on their hazard lights.

Human users in the vicinity of the autonomous vehicle may have interest in providing a request to the autonomous vehicle to influence the behavior of the autonomous vehicle. As an example, if an autonomous vehicle is blocking the passing lane, a driver behind the autonomous vehicle may wish to request that the autonomous vehicle move to an alternate lane. In other instances, drivers may request that the autonomous vehicle slow down, speed up, or pull over.

However, allowing surrounding users to impact the behavior of the autonomous vehicle may result in frivolous or spam requests. In addition, the autonomous vehicle must always maintain the global mission, which is to maneuver the vehicle from a starting point to a destination, all the while ensuring both safe and legal operation of the autonomous vehicle.

Therefore, a need exists for a system for an autonomous vehicle to allow for input from surrounding drivers while preventing frivolous requests and maintaining safe operation of the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an autonomous vehicle includes an autonomy computing system and an exterior surface displaying an indicium. The autonomy computing system includes an incentivized behavior module. The autonomy computing system further includes at least one processor and at least one memory. The processor is configured to establish communication between a client device of a user and the autonomous vehicle using the indicium. The processor is configured to receive, at least one request from the client device, the at least one request including a desired action of the autonomous vehicle. The processor is configured to initiate execution of the desired action. The processor is configured to communicate to the client device whether the autonomous vehicle will complete the requested action.

In another aspect, a method of requesting an action of an autonomous vehicle is provided. The method includes establishing communication, between a client device of a user and the autonomous vehicle. The method includes receiving, at least one request from the client device, the at least one request including a desired action of the autonomous vehicle. The method includes initiating execution of the desired action. The method includes communicating to the client device whether the autonomous vehicle will complete the requested action.

In yet another aspect, an autonomy computing system includes an incentivized behavior module. The autonomy computing system further includes at least one processor and at least one memory. The processor is configured to establish communication between a client device of a user and the autonomy computing system. The processor is configured to receive, at least one request from the client device, the at least one request including a desired action of the autonomy computing system. The processor is configured to initiate execution of the desired action. The processor is configured to communicate to the client device whether the autonomy computing system will complete the requested action.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts an autonomous vehicle;

FIG. 2 is a block diagram of the vehicle that receives incentivized behavior requests;

FIG. 3 is a flow chart that comprises an exemplary method of receiving a request for an action of an autonomous vehicle from a client device;

FIG. 4 is an example of the available autonomous vehicle actions that are displayed on the client device once communication has been established;

FIG. 5 depict examples of the message received on the client device after the request is approved;

FIG. 6 depict examples of the message received on the client device after the request denied; and

FIG. 7 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

As described briefly above, there are times when autonomous vehicles may suffer from courtesy failures when navigating traffic. While the autonomous vehicle is constantly receiving and analyzing data to effectively operate the autonomous vehicle, there may be instances where drivers or vehicles in the vicinity of the autonomous vehicle desire specific actions from the autonomous vehicle (e.g. if the autonomous vehicle is, for some reason, impeding traffic or otherwise inconveniencing human drivers). There are benefits to allowing surrounding users to submit requests to an autonomous vehicle to improve the operation of the autonomous vehicle while preventing frivolous requests and maintaining safe operation of the autonomous vehicle. For example, public perception of the safety and efficiency of autonomous vehicles may improve. Acquiescing to such requests, however, may delay or otherwise impair the autonomous vehicle's ability to achieve its own mission.

As will be described in detail below, an incentivized behavior system which is a part of the autonomy stack of the autonomous vehicle may allow for requests to change a behavior of the autonomous vehicle to be submitted to the autonomous vehicle by surrounding drivers. While the autonomous vehicle may consider requests of vehicles in the vicinity, it is imperative that any requests not violate the global mission of the autonomous vehicle, which is to navigate the vehicle from a start point to an end point while always operating in a safe manner. Any requests are processed through the autonomy system to ensure that safe operation is maintained. One way to prevent spam requests is to require a small payment from the user in order to process the request. Such payments may include the exchange of currency, institutional credits or “points,” rewards credits, or other non-currency credit of some value to the holder. In certain embodiments, payment for a particular action may be borne by multiple users in a cumulative manner. When payment contributions exceed a threshold, the action may then be executed at an appropriate (i.e., safe and legal) time.

In certain embodiments, data relating to requests, payments, and actions executed is collected and transmitted to a centralized location, such as mission control or another control center. Such data can be processed and analyzed to later incorporate improvements to the autonomous vehicle.

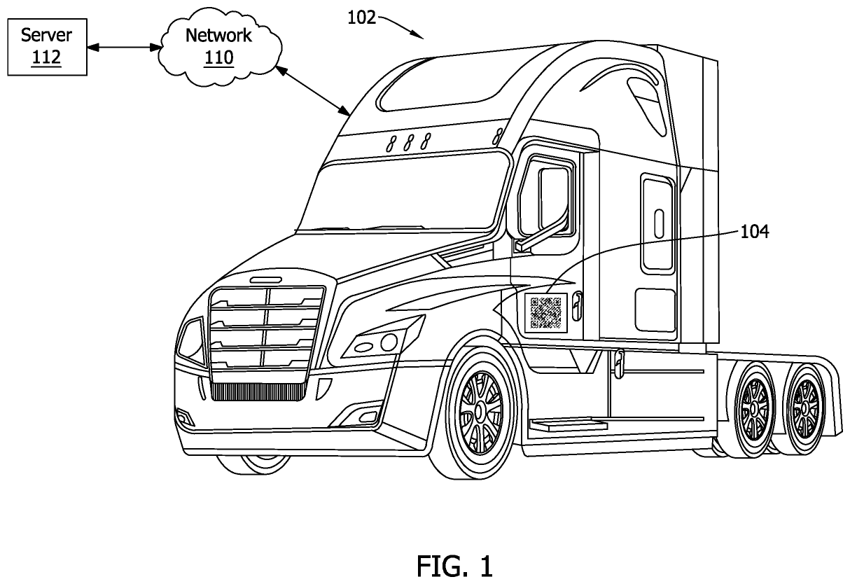

FIG. 1 depicts an autonomous vehicle 102. Autonomous vehicle 102 includes an autonomy system that may be completely autonomous (fully autonomous), such as self-driving, driverless, or Level 4 autonomy, or semi-autonomous, such as Level 3 autonomy. As used herein the term “autonomous” includes both fully autonomous and semi-autonomous. The autonomy system may be structured on at least three aspects of technology: (1) perception, (2) maps/localization, and (3) behaviors planning and control.

The autonomous vehicle 102 is connected to a network 110, and server 112 is connected to the network 110. The autonomous vehicle 102 includes an indicium 104 located on the side of the autonomous vehicle. In other embodiments, the indicium 104 may be located singly or in combination along the rear or front of the autonomous vehicle, or along a trailer being hauled by the autonomous vehicle. The indicium 104 displayed on the body of the vehicle 102 may include a machine readable image, such as a QR code, a bar code, a radio frequency, a network identifier (e.g., a service set identifier (SSID) of the Wi-Fi network system or the Wi-Fi hotspot system).

The function of the perception aspect is to sense an environment surrounding the vehicle 102 and interpret the environment. To interpret the surrounding environment, a perception module or engine in the autonomy system of the vehicle 102 may identify and classify objects or groups of objects in the environment. For example, a perception module may be associated with various sensors (e.g., light detection and ranging (LiDAR), camera, RADAR, etc.) of the autonomy system and may identify one or more objects (e.g., pedestrians, other vehicles, lane markings, road signs, debris, nearby structures, etc.) and features of the roadway (e.g., lane lines) around the vehicle 102, and classify the objects identified.

The mapping and localization aspect of the autonomy system may be configured to determine where on a digital map the vehicle 102 is currently located. The digital map may be pre-established or generated dynamically based on features detected in the environment. One way to do this is to sense the environment surrounding the vehicle 102 (e.g., via the perception module), such as by detecting static objects (e.g., traffic lights, lane markings, road signs, markers, bridges, geographic features, etc.) from data collected via the sensors of the autonomy system, and to correlate features of the sensed environment with details (e.g., digital representations of the features of the sensed environment) on the digital map. In certain embodiments, features may be localized independently using global navigation satellite system (GNSS) data or in conjunction with registering detected static features on the digital map.

Once the systems on the vehicle 102 have determined the location of the vehicle 102 with respect to the digital map features (e.g., location on the roadway, upcoming intersections, road signs, etc.), the vehicle 102 can plan and execute maneuvers or routes with respect to the features of the digital map. The behaviors and planning aspects of the autonomy system may be configured to make decisions about how the vehicle 102 should move through the environment to arrive at the vehicle's destination or realize a vehicle performance goal. The autonomy system may receive and analyze information from the perception and understanding module and the mapping and localization module to determine where the vehicle 102 is generally located and specifically positioned relative to the surrounding environment and identify other surrounding objects and assess activity among traffic actors.

The vehicle 102 is capable of communicatively coupling to the remote server 112 via the network 110. Remote server 112 may be embodied, for example, as a server at a centralized control center, an operator or fleet hub, or mission control. The vehicle 102 may not necessarily connect with the network 110 or the server 112 while it is in operation (e.g., travelling along the roadway). That is, the server 112 may be remote from the vehicle, and the vehicle 102 may deploy with all the necessary perception, localization, and vehicle control software and data necessary to complete the vehicle 102's mission fully autonomously or semi-autonomously.

This disclosure refers to vehicle 102 as the autonomous vehicle, it is understood that the vehicle 102 could be any type of vehicle including a truck (e.g., a tractor trailer), an automobile, a mobile industrial machine, etc. Although self-driving or driverless autonomous systems are described herein, the autonomous system could alternatively be semi-autonomous having varying degrees of autonomy or autonomous functionality.

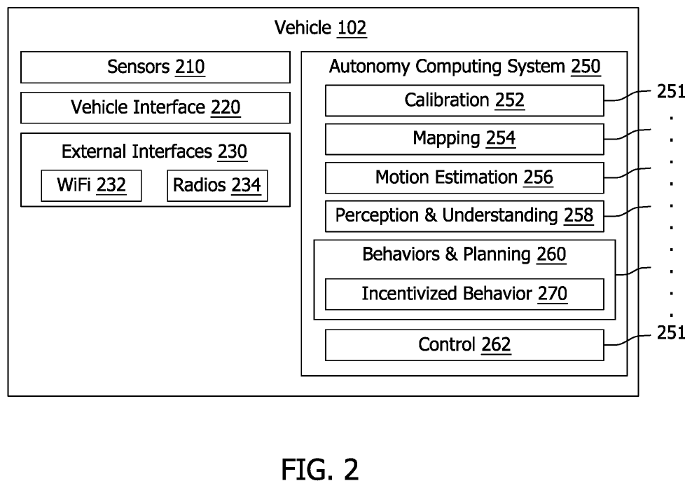

FIG. 2 is a block diagram of the vehicle 102 that receives requests for behaviors, or actions. The autonomous vehicle 102 includes a plurality of sensors 210, a vehicle interface 220, external interfaces 230, and an autonomy computing system 250.

Sensors 210 may include radio detection and ranging (RADAR) devices, light detection and ranging (LiDAR) sensors, cameras, and acoustic sensors. Sensors 210 may further include an inertial navigation system (INS) configured to determine states such as the location, orientation, and velocity of autonomous vehicle 102. INS may include at least one GNSS receiver configured to provide positioning, navigation, and timing using satellites. INS may also include at least one inertial measurement unit (IMU) configured to measure motion properties such as the angular velocity, linear acceleration, and/or orientation of autonomous vehicle 102.

Autonomous vehicle 102 further includes vehicle interface 220, which interfaces with an electronic control unit (ECU) (not shown) of autonomous vehicle 102 to control, for example, the operation of the autonomous vehicle 102 by acceleration, braking, or steering.

Autonomous vehicle 102 may further include at least one external interface 230 configured to communicate with external devices or systems such as another vehicle. External interface 230 may comprise Wi-Fi 232, other radios 234 such as Bluetooth, or other suitable wired or wireless transceivers such as cellular communication devices.

Autonomous vehicle 102 further includes an autonomy computing system 250. Autonomy computing system 250 controls the movement of autonomous vehicle 102 in part using commands and information received through vehicle interface 220. Autonomy computing system 250 ensures the safe and legal operation of autonomous vehicle 102 to achieve a given mission.

In one embodiment, autonomy computing system 250 includes modules 251 for performing various functions. Modules 251 may include a calibration module 252, a mapping module 254, a motion estimation module 256, perception and understanding module 258, behaviors and planning module 260, and a control module 262. Behaviors and planning module 260 may include an incentivized behavior submodule 270 configured to receive external requests (e.g. from surrounding drivers via external interface 230) to perform an action of the autonomous vehicle 102. Modules 223 and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 102. A given module may be implemented or executed by a single processor of autonomy computing system 250, or may be divided among two or more processors of autonomy computing system 250. Likewise, multiple instances of autonomy computing system 250 may be utilized onboard the autonomous vehicle 102.

In the example embodiment, the vehicle 102 assesses the environment surrounding autonomous vehicle 102 based on the data collected from sensors 210, processed by the autonomy computing system 250 and, more specifically, perception and understanding module 258. Perception and understanding module 258 interprets the sensed environment by identifying and classifying objects or groups of objects in the environment. For example, perception and understanding module 258 in combination with various sensors 210 (e.g., LiDAR, camera, RADAR, etc.) as well as other modules (e.g., motion estimation 256 or mapping 254) of autonomous vehicle 102 may identify one or more objects (e.g., pedestrians, vehicles, debris, etc.) and features of a roadway (e.g., lane lines) around autonomous vehicle 102, and classify the objects in the road distinctly.

In one embodiment, a method of controlling an autonomous vehicle, such as autonomous vehicle 102, includes collecting perception data representing a perceived environment of autonomous vehicle 102 using perception and understanding module 258, comparing the perception data collected with digital map data, and modifying operation of the vehicle consistent with the difference between the perception data and the digital map data. In certain embodiments, the method may include constructing a local map based on perception data without reference to a fixed, or pre-established, base digital map.

In the example embodiment, behaviors and planning module 260 and control module 262 plan and implement one or more behavior-based trajectories to operate autonomous vehicle 102 in a manner similar to that of a human driver. The behaviors and planning module 260 uses inputs from the perception and understanding module 258 or mapping module 254 to generate trajectories or other planned behaviors. For example, behavior and planning module 260 may generate potential trajectories or actions and select one or more of the trajectories to follow or enact as the vehicle travels along the road. The trajectories may be generated based on proper (i.e., legal, customary, and/or safe) interaction with other static and dynamic objects in the environment. Behaviors and planning module 260 may generate local objectives (e.g., following rules or restrictions) such as, for example, lane changes, stopping at stop signs, etc. Additionally, behavior and planning module 260 may be communicatively coupled to, include, or otherwise interact with motion planners, which may generate paths and/or actions to achieve local objectives. Local objectives may include, for example, reaching a goal location while avoiding obstacle collisions. Control module 262 then executes the plans by sending commands to the vehicle ECU via the vehicle interface 220.

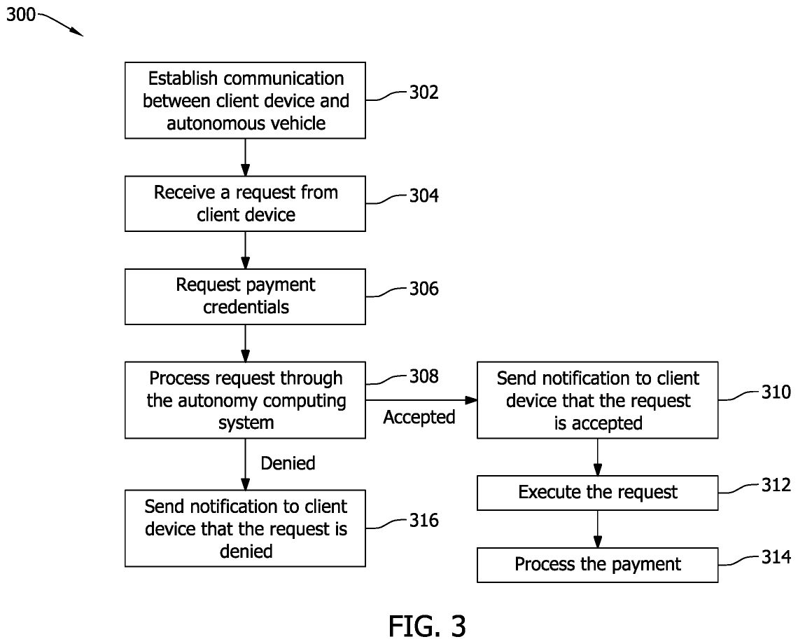

FIG. 3 is a flow chart that comprises an exemplary method 300 of receiving a request for an action of an autonomous vehicle from a client device, in accordance with embodiments of the present disclosure. By way of a non-limiting example, the client device may be a Wi-Fi enabled client device such as a cell phone, tablet, laptop, or on-board vehicle device.

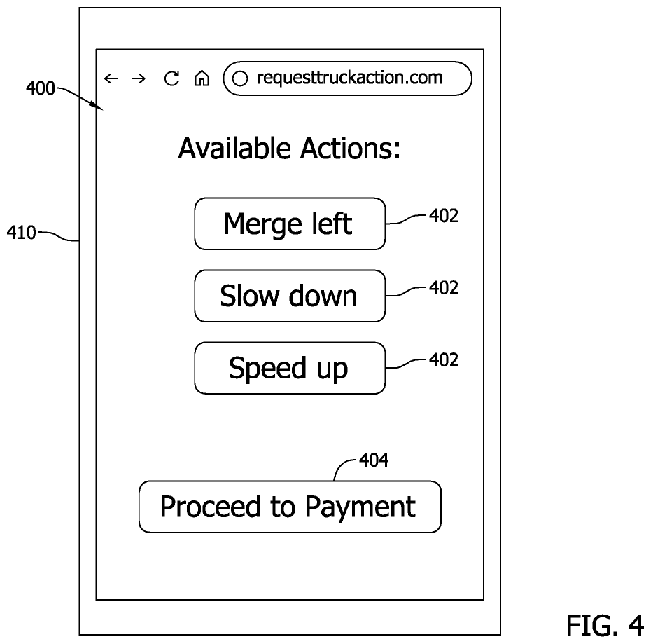

Firstly, a client device establishes 302 communications with an autonomous vehicle. Communication may be established by the user scanning an indicium 104 displayed on the body of the vehicle with the client device. By way of a non-limiting example, the indicium 104 displayed on the body of the vehicle 100 may include a machine-readable image, such as a QR code or barcode, a radio frequency, or a network identifier such as an SSID of the Wi-Fi network system or the Wi-Fi hotspot system. The machine readable image may be scanned by the client device. Indicium 104 connects client device 140 with the autonomous vehicle through a network, such as network 110. The client device 410 in FIGS. 4-6 may comprise a handheld mobile device, tablet, camera or any other device that is able to the sense or read the indicium 104, establish communication with vehicle 102, display information to the user, and communicate with the vehicle 102.

In one embodiment, the vehicle broadcasts a network identifier of a wireless communication equipment installed in the vehicle. By way of a non-limiting example, the wireless communication equipment may be a Wi-Fi network system or a Wi-Fi hotspot system, such as Wi-Fi 232. The network identifier may be a name of the wireless communication equipment. In case the wireless communication equipment is the Wi-Fi network or the Wi-Fi hotspot system, the network identifier may be an SSID. The broadcast network identifier may be received by the client device, and a user of the requestor device may initiate and transmit a request to connect with the wireless communication equipment. In some embodiments, the requestor device may automatically generate and transmit the request to connect with the wireless communication equipment.

Once communication is established, the client device may present a variety of options from which the user can select one or more of the options to request of the vehicle. For example, the options may include “slow down”, “speed up”, “merge right”, “merge left”, “exit highway”, “pull over”, or “turn on hazard lights”. The user has the option to select one or more of these options. In response to receiving 304 the request from the client device, the incentivized behavior module 270 requests 306 payment credentials. To prevent frivolous requests, the user must enter payment credentials, such as credit or debit card details for currency transactions and information relating to an on-line payment platform etc. in order to proceed. In certain embodiments, payment credentials may include credentials for non-currency transactions exchanging rewards points, loyalty credits, or other non-cash credit. In some embodiments, the client device may provide access to a digital wallet to provide payment credentials.

The incentivized behavior module 270 processes 308 the request through the autonomy computing system to determine if the request can be fulfilled. For example, behaviors and planning module 260 may process the request to determine if and how the action can be taken. In order to be accepted, the request must not violate the global mission of the autonomous vehicle, which is to navigate the autonomous vehicle from a starting point to and ending point while ensuring safe and legal operation within the conditions.

Once the autonomous vehicle determines whether to accept or deny the request, the vehicle sends 310, 316 a notification to the client device to relay the acceptance or denial. In the event that the request is denied, no further action is needed. However, in certain embodiments, incentivized behavior module 270 may process a refund of any payments received. In the event the request is accepted, the autonomous vehicle executes 312 the request and processes 314 the payment for completion of the request.

FIG. 4 is an example of the available autonomous vehicle actions that are displayed on the client device once communication has been established. In one embodiment, the QR code may open a web page or application user interface (UI) 400. The UI 400 includes several selectable options 402. The UI 400 further includes a submission button 404 which prompts the user to input payment information. The UI 400 may be displayed on the client device 410.

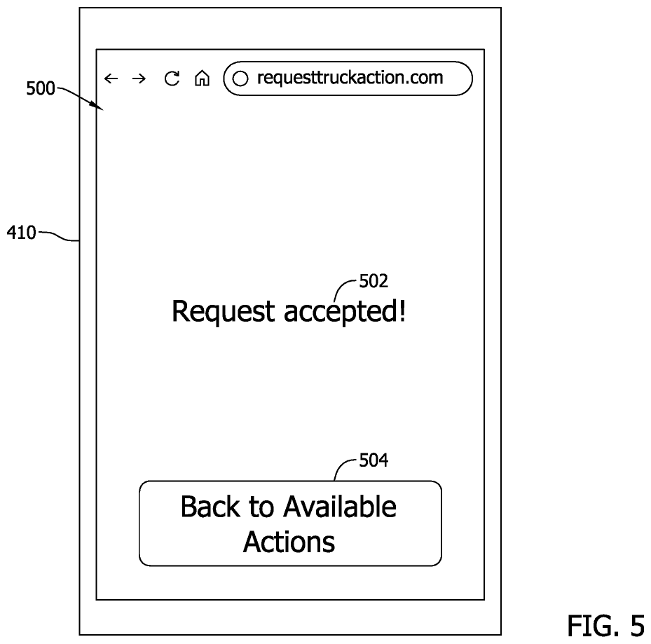

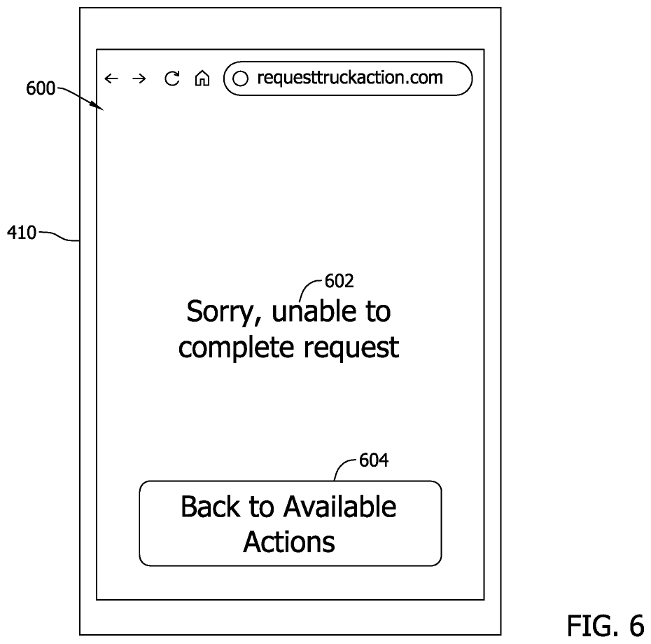

FIGS. 5 and 6 depict examples of the message received on the client device after the request communicated by the client device has been processed by the controller of the autonomous vehicle. If the client device request is accepted by the autonomous vehicle, a UI 500 is displayed on the client device, including an acceptance message 502. In FIG. 5, the exemplary acceptance message is “Request accepted”. It should be understood that the acceptance message may comprise any message that confirms the autonomous vehicle's acceptance of the change in operation of the autonomous vehicle proposed using the client device, including, without limitation, human readable text or graphics. UI 500 may also include a link 504 which returns the client device 410 to UI 400 to make another request. If the request is denied, a UI 600 is presented on the client device, including a denial message 602. UI 600 may also include a link 604 which returns the client device to UI 400 to make another request.

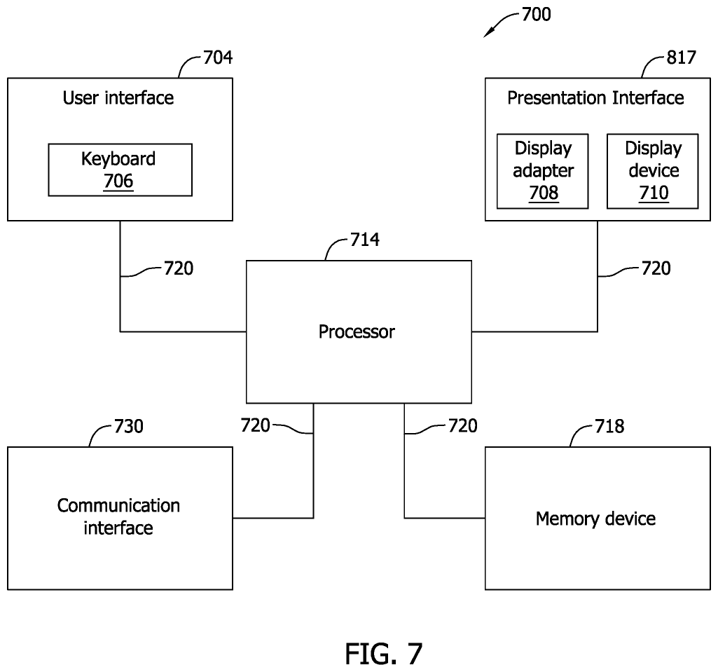

Methods described herein may be implemented on autonomy computing system 250. Autonomy computing system 250 described herein may be any suitable computing device 700 and software implemented therein. FIG. 7 is a block diagram of an example computing device 700.

Computing device 700 includes a processor 714 and a memory device 718. Processor 714 is coupled to user interface 704, presentation interface 717, and memory device 718 via a system bus 720. In the example embodiment, processor 714 communicates with the user, such as by prompting the user via presentation interface 717 and/or by receiving user inputs via user interface 704. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition and/or meaning of the term “processor.”

In the example embodiment, memory device 718 includes one or more devices that enable information, such as executable instructions and/or other data, to be stored and retrieved. Moreover, memory device 718 includes one or more computer readable media, such as, without limitation, dynamic random access memory (DRAM), static random access memory (SRAM), a solid state disk, and/or a hard disk. In the example embodiment, memory device 718 stores, without limitation, application source code, application object code, configuration data, additional input events, application states, assertion statements, validation results, and/or any other type of data. Computing device 700, in the example embodiment, may also include a communication interface 730 that is coupled to processor 714 via system bus 720. Moreover, communication interface 730 is communicatively coupled to data acquisition devices.

In the example embodiment, processor 714 may be programmed by encoding an operation using one or more executable instructions and providing the executable instructions in memory device 718. In the example embodiment, processor 714 is programmed to select a plurality of measurements that are received from data acquisition devices.

In operation, a computer executes computer-executable instructions embodied in one or more computer-executable components stored on one or more computer-readable media to implement aspects of the present disclosure described and/or illustrated herein. The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

In certain embodiments, computing device 700 includes a user interface 704 that receives at least one input from a user. User interface 704 may include a keyboard 706 that enables the user to input pertinent information. User interface 704 may also include, for example, a pointing device, a mouse, a stylus, a touch sensitive panel (e.g., a touch pad and a touch screen), a gyroscope, an accelerometer, a position detector, and/or an audio input interface (e.g., including a microphone). Moreover, computing device 700 includes a presentation interface 717 that presents information, such as input events and/or validation results, to the user. Presentation interface 717 may also include a display adapter 708 that is coupled to at least one display device 710. More specifically, in the example embodiment, display device 710 may be a visual display device, such as a cathode ray tube (CRT), a liquid crystal display (LCD), a light-emitting diode (LED) display, and/or an “electronic ink” display. Alternatively, presentation interface 817 may include an audio output device (e.g., an audio adapter and/or a speaker) and/or a printer.

An example technical effect of the methods, systems, and apparatus described herein includes at least one of: (a) establishing communication between surrounding users and an autonomous vehicle (b) enabling surrounding drivers to request certain courtesy maneuvers and behaviors, i.e., actions, of the autonomous vehicle or (c) requesting payment or other incentives from the requesting user to prevent frivolous requests.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or a electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle, the autonomous vehicle comprising:
an exterior surface displaying an indicium; and
an autonomy computing system, the autonomy computing system comprising at least one processor and at least one memory storing computer executable instructions defining an incentivized behavior module, the computer executable instructions, upon execution by the processor, configuring the processor to:
establish communication between a client device of a user and the autonomous vehicle using the indicium;
receive at least one request from the client device, the at least one request including a desired action of the autonomous vehicle;
initiate execution of the desired action; and
communicate to the client device the autonomous vehicle will complete the desired action.

2. The autonomous vehicle of claim 1, wherein the user scans, with the client device, the indicium visible on the autonomous vehicle in order to establish communication.

3. The autonomous vehicle of claim 1, wherein the vehicle broadcasts a network identifier of a wireless communication equipment installed on the autonomous vehicle in order to establish communication.

4. The autonomous vehicle of claim 1, wherein the processor presents a list of options to present on the client device, the list including available options from which the user may request.

5. The autonomous vehicle of claim 1, wherein, in response to receiving the request from the client device, the processor requests payment credentials from the user.

6. The autonomous vehicle of claim 1, wherein upon receiving the request from the client device, the processor determines if the request is permitted.

7. The autonomous vehicle of claim 6, wherein upon determining the request is permitted, initiating execution of the desired action.

8. A method of requesting an action of an autonomous vehicle, the method comprising:
establishing communication between a client device of a user and the autonomous vehicle;
receiving at least one request from the client device, the at least one request including a desired action of the autonomous vehicle;
initiating execution of the desired action; and
communicating to the client device the autonomous vehicle will complete the requested action.

9. The method of claim 8, wherein establishing communication includes scanning, by the client device, an indicium visible on the autonomous vehicle.

10. The method of claim 8, wherein establishing communication includes broadcasting a network identifier of a wireless communication equipment installed on the autonomous vehicle.

11. The method of claim 8, further comprising presenting a list of options on a user interface on the client device, the list including available options from which the user may request.

12. The method of claim 8, further comprising, in response to receiving the request from the client device, requesting payment credentials from the user.

13. The method of claim 8, further comprising, upon receiving the request from the client device, determining if the request is permitted.

14. The method of claim 13, wherein upon determining the request is permitted, execution of the desired action is initiated.

15. An autonomy computing system comprising at least one processor and at least one memory storing computer executable instructions defining an incentivized behavior module, the computer executable instructions, upon execution by the processor, configuring the processor to:
establish communication, between a client device of a user and the autonomy computing system;
receive, at least one request from the client device, the at least one request including a desired action of the autonomy computing system;
initiate execution of the desired action; and
communicate to the client device whether the autonomy computing system will complete the requested action.

16. The autonomy computing system of claim 15, wherein the user scans, with the client device, an indicium visible on the autonomy computing system in order to establish communication.

17. The autonomy computing system of claim 15, wherein the autonomy computing system broadcasts a network identifier of a wireless communication equipment installed on the autonomy computing system in order to establish communication.

18. The autonomy computing system of claim 15, wherein the processor presents a list of options to present on the client device, the list including available options from which the user may request.

19. The autonomy computing system of claim 15, wherein, in response to receiving the request from the client device, the processor requests payment credentials from the user.

20. The autonomy computing system of claim 15, wherein upon receiving the request from the client device, the processor determines if the request is permitted, and, upon determining the request is permitted, executing the desired action.
